(19) United States
(12) Patent Application Publication
(10) Pub. No.: US 2008/0212888 A1
(43) Pub. Date: Sep. 4, 2008

(54) Frame Region Filters

(76) Inventor: Barinder Singh Rai, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/680,795

(22) Filed: Mar. 1, 2007

(51) Int. Cl. G06K 9/40; G09G 5/02

(52) U.S. Cl. 382/260; 345/698

(57) ABSTRACT

One embodiment is directed to a display controller that comprises: (a) a selecting circuit and (b) a filtering circuit. The selecting circuit selects pixels of a frame of image data that are within at least one region of the frame designated for filtering. The filtering circuit modifies the selected pixels according to a filtering operation specified for the filtering region in which the selected pixels are located. In addition, in one embodiment, the selecting circuit selects pixels that are within one of at least two filtering regions, and the filtering circuit modifies the selected pixels according to one of at least two distinct filtering operations. Other embodiments are directed to hardware implemented methods for filtering image data.

### FIELD OF INVENTION

The field of invention relates to methods and apparatus for filtering regions of a digital image.

### BACKGROUND

Digital cameras capture an image with an image sensor, such as a charge-coupled device (CCD) or a complementary metal-oxide semiconductor (CMOS) sensor. When a photograph is taken with a digital camera, the image sensor captures and stores an image in a memory device, such as a flash memory, instead of on film.

Digital cameras are often being incorporated into mobile devices, such as mobile telephones. Mobile-device cameras must be smaller, cheaper, and consume less power than dedicated digital cameras. In addition, mobile-device cameras must be robust to withstand dropping and other abuse. Because of these constraints, the cameras used in mobile devices frequently use CMOS sensors. CMOS sensors are smaller, less expensive, and use less power than CCD sensors. In addition, to keep costs down and minimize power requirements, the sensors used in mobile devices typically capture images at a lower resolution than the sensors used in dedicated digital cameras.

One reason for the popularity of mobile-device cameras is that they provide the ability to take advantage of photo opportunities that arise when all that the consumer has at hand is their mobile device. People don't always have their digital camera with them, but many frequently do not go anywhere without their mobile phone.

However, consumers are often disappointed with the quality of the photographs that they take with their mobile-device cameras. Lower quality images are produced for several reasons. First, the lenses that are used in mobile-device cameras are much smaller and less expensive than those used in dedicated digital cameras. As a result, significantly less light reaches the sensor as compared with a dedicated camera. Another reason is that the image may be captured in low-light conditions. Cameras used in mobile devices often use an LED flash or no flash at all. In contrast, dedicated digital cameras generally use a xenon flash, which provides greater illumination. In addition, the CMOS sensors that are typically used in mobile devices tend not to perform as well as CCD sensors in low-light conditions.

In some cases, it is possible to improve the quality of an image captured with a mobile device camera by using one or more image processing “filters.” In addition, filters may be used to add a special effect to an image. Thus, there is a particular need to filter images captured with a mobile-device camera. A variety of different types of filters are available, e.g., blurring, sharpening, solarizing, contrast-adjusting, and color-correcting filters. In addition, to enhance an image only a portion of the image may need filtering.

A filter may be applied to a digital image using special-purpose software running on a personal computer. However, photograph editing software requires several relatively powerful hardware components and prodigious amounts of memory. For example, the current system requirements for one exemplary photo editing software product are at least 320 Mb of RAM, at least 650 Mb of hard disk space, a monitor with 1,024×768 resolution, a 6-bit video card, a CD-ROM drive, and a Pentium® class processor. Moreover, consumers who use mobile device cameras are often casual photographers, as opposed to semi-expert, hobby and professional photographers. As casual photographers, consumers are often not willing to purchase and learn to use photograph editing software. In addition, consumers are often not willing to wait to apply a filter. If the consumer must take the camera home and transfer the image to a computer, many casual photographers, unwilling to wait many hours or days, will simply skip applying a filter.

Accordingly, there is a need for methods and apparatus for filtering one or more regions of a digital image. In particular, there is a need for filtering of the images captured with a mobile-device camera that can be performed substantially contemporaneously with capturing the image.

### SUMMARY

One embodiment is directed to a display controller. The display controller comprises: (a) a selecting circuit and (b) a filtering circuit. The selecting circuit selects pixels of a frame of image data that are within at least one region of the frame designated for filtering. The filtering circuit modifies the selected pixels according to a filtering operation specified for the filtering region in which the selected pixels are located. In addition, in one embodiment, the selecting circuit selects pixels that are within one of at least two filtering regions, and the filtering circuit modifies the selected pixels according to one of at least two distinct filtering operations.

Another embodiment is directed to hardware implemented method for filtering image data. The method comprises: (a) receiving at least one frame of image data; (b) selecting pixels of the frame that are within a region of the frame designated for filtering; and (c) modifying the selected pixels according to a filtering operation specified for the region. In addition, in one embodiment, the at least one frame of image data includes two or more sequential frames. A first frame in the sequence of frames is at a first resolution. A second frame in the sequence is at a second resolution, and the first resolution is lower than the second resolution.

Yet another embodiment is directed to a hardware implemented method for filtering image data. The method comprises: (a) receiving at least one first frame of image data; (b) selecting pixels of the first frame that are within a region designated for filtering; (c) modifying the selected pixels according to the filtering operation specified for the filtering region in which the selected pixels are located; and (d) displaying the first frame on a display device. At least two filtering regions are designated and at least two filtering operations are specified. The step (d) of displaying is performed after the step (c) of modifying the selected pixels.

### BRIEF DESCRIPTION OF THE DRAWINGS

FIG. 1 illustrates an exemplary frame having two filtering regions designated for filtering according to first and second filtering operations.

FIG. 2 is a block diagram of a graphics display system 20 for filtering regions of a digital image according to some of the described embodiments, which includes a pixel modifying unit.

FIG. 3 is a block diagram illustrating one example of the pixel modifying unit of FIG. 2.

FIG. 4 is a flow diagram of a method according to one embodiment.

FIG. 5 is a flow diagram of a method according to another embodiment.

FIGS. 6A and 6B respectively depict an original image of a scene before and after prophetic filtering.

FIG. 7 depicts an original image of a scene after a prophetic filtering of a frame shaped region.

In the drawings and description below, the same reference numbers are used in the drawings and the description to refer to the same or like parts, elements, or steps.

### DETAILED DESCRIPTION

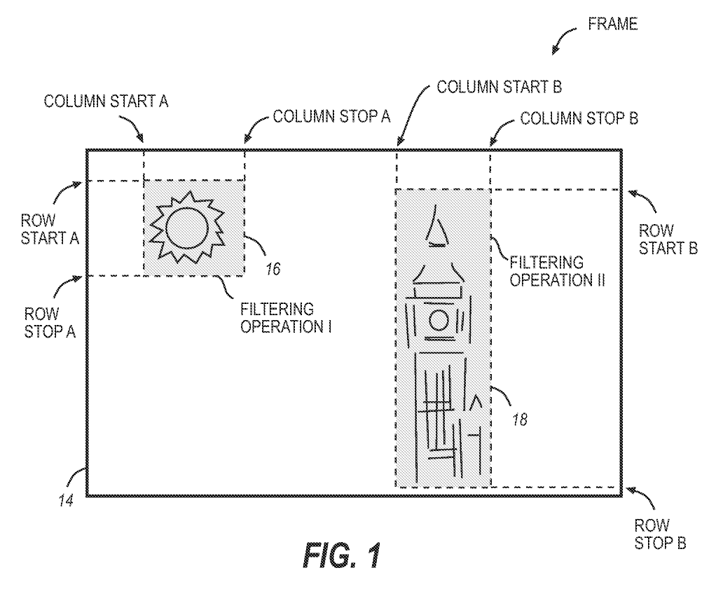

FIG. 1 is an illustration of a digital image or frame 14 having two filtering regions 16, 18 (shown shaded) designated for filtering. Each region has horizontal start and stop coordinates, and vertical start and stop coordinates. Region 16 is designated for filtering by a first filtering operation while the Region 18 is designated for filtering by a second filtering operation. The remainder of the frame is not designated for filtering.

The filtering regions 16, 18 may be specified in a variety of ways. For instance, a user may select a region to be filtered by inputting coordinates. The user may employ a stylus with a touch-sensitive screen to select a region. In another alternative, a user may select from among several predetermined regions presented on the display screen. In addition to selection by a user, the region to be filtered may be selected by an algorithm or a machine performing the algorithm, where the algorithm selects regions based upon an analysis of the image data.

A “filter,” as this term is used in this specification and in the claims, means a device for performing a process that receives an original image as an input, transforms the individual pixels of the original image in some way, and produces an output image. In addition to a device for performing such a process, the term also refers to the process itself. Examples include blurring, sharpening, brightness-adjusting, contrast-adjusting, gray-scale converting, color replacing, solarizing, inverting, duotoning, posterizing, embossing, engraving, and edge detecting filters. This list is illustrative, but not comprehensive, of the types of filter may be employed with the claimed inventions. Filters may be applied to gray-scale or color pixels. With respect to color pixels, the filter may be applied to all channels or to only selected color channels.

Generally, filters may be classified by the number of pixels the filter requires as input. A first type of filter requires only a single pixel as input and modifies the input in some way, such as by applying a formula to the input pixel or by operating on the input pixel with a value obtained from a look-up table. For example, the filter may add or subtract a constant to the input pixel value. Alternatively, the filter may multiply or divide an input pixel by a constant. A filter of this type could be used to lighten dark pixels in a gray-scale image. This type of filter may perform one or more tests to determine if a particular pixel should be modified.

A second type of filter requires multiple pixels as input. As another example, a matrix of pixels may be required as input, such as a 1×3, 3×1, 3×3 or 9×9 matrix of pixels. Typically, the second type of filter performs an operation using all of the pixels in the matrix to produce a result, and then replaces the pixel at the center of the matrix with the result. As with the first type, formulas, look-up tables, and tests to determine whether to modify may be employed. As an example, consider a box filter that requires a 3×1 matrix of pixels as input. Three sequential pixels on one line of an image are averaged and the center pixel is replaced with the average. A weighting schemed may be applied before the formula is applied. Continuing the example, the three pixels may be multiplied respectively by coefficients of 0.5, 1.0, and 0.5 before the average is calculated.

Regardless of whether a particular filter is of the first or second type, the filtering operation, i.e., the effect that the filter produces, may be varied by changing the coefficients used by the filter. For example, different filtering operations may be selected using a filter that requires only a single pixel as input by changing the value of a constant to be added to an input pixel or changing a parameter used in a test to determine whether a particular pixel should be modified.

Similarly, different filtering operations may be selected using a filter that requires multiple pixels as input by changing one or more of the coefficients used by the filter. For example, consider a convolution matrix filter that uses a 3×3 filter window. Assume that this filter first multiplies each pixel in the filter window by a coefficient, calculates the sum of the products, divides this sum by the number of pixels in the window, and then replaces the pixel at the center of the window with the result. If an equal weighting is applied to each of the pixels, as shown below, a blur effect may be achieved:

| | | |
|---|---|---|
| 1 | 1 | 1 |
| 1 | 1 | 1 |
| 1 | 1 | 1 |

On the other hand, if the weighting scheme shown below is applied an effect that sharpens the image may be achieved.

| | | |
|---|---|---|
| −1 | −1 | −1 |
| −1 | 9 | −1 |
| −1 | −1 | −1 |

Thus, by changing the weighting scheme or coefficients, the filter may be used to create either a blurring or sharpening effect. Further, by varying the weights, varying degrees of blurring and sharpening can be achieved. In addition, by varying the weights an edge detection effect, an embossing effect, or an engraving effect may be obtained.

According to the claimed inventions, distinct filtering operations may be applied in real-time to one of more regions of a digital image designated as a filtering region. This permits a user to immediately see the effect of a particular filtering operation. The user may then modify the filtering operation if desired. This provides the user with the capability to improve the quality of or to apply a special effect to a digital image before it is captured. This also permits a user to simultaneously preview the effect of two or more filtering operations and to select one of the previewed effects before the image is captured.

Methods and apparatus of the claimed inventions may be used in “mobile devices.” A mobile device is a computer or communication system, such as a mobile telephone, personal digital assistant, digital music player, digital camera, or other similar device. Embodiments of the claimed inventions may be employed, however, in any device capable of processing image data, including but not limited to computer and communication systems and devices generally.

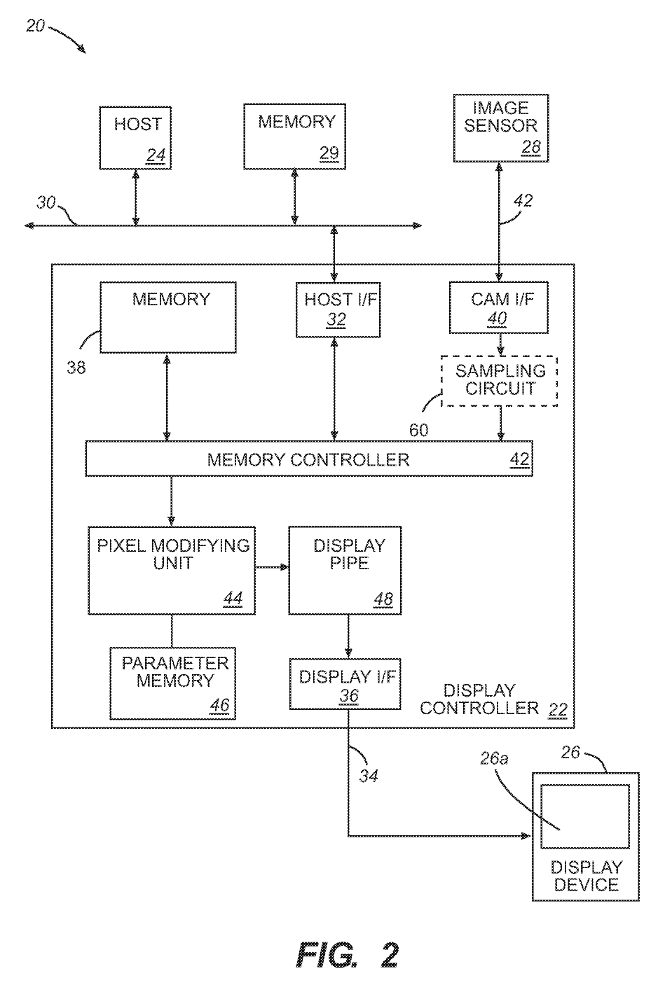

FIG. 2 shows a block diagram of a graphics display system 20 for filtering regions of a digital image according to one embodiment of the claimed inventions. The system 20 may be a mobile device. Where the system 20 is a mobile device, it is typically powered by a battery (not shown). The system 20 may include a host 24, a graphics display device 26, and one or more image data sources, such as a camera module or image sensor 28 (“camera”). Because the host 24 may be a source of image data, the phrase “image data source” in intended to include the host 24.

The graphics display system 20 includes a display controller 22 that interfaces the host 24 and other image data sources with the display device 26. In one embodiment, the display controller 22 is a separate integrated circuit from the remaining elements of a system, that is, the display controller is “remote” from the host, camera, and display device. In alternative embodiments, one or more functions of the display controller 22 may be performed by other units in a system.

The host 24 is typically a microprocessor, but may be a digital signal processor, a computer, or any other type of device or machine that may be used to control operations in a digital circuit. Typically, the host 24 controls operations by executing instructions that are stored in or on a machine-readable medium. The host 24 communicates with the display controller 22 over a bus 30 to a host interface 32 in the display controller. Other devices may be coupled with the bus 30. For instance, a memory 29 may be coupled with the bus 30. The memory 29 may, for example, store instructions or data for use by the host 24, or image data that may be rendered using the display controller 22. The memory 29 may be an SRAM, DRAM, Flash, hard disk, optical disk, floppy disk, or any other type of memory.

The display device 26 has a display area 26a where image data is displayed. A display device bus 34 couples the display device 26 with the display controller 22 via a display device interface 36 in the display controller 22. LCDs are typically used as display devices in portable digital appliances, such as mobile telephones, but any device(s) capable of rendering pixel data in visually perceivable form may be employed. The term “display device” is used in this specification to broadly refer to any of a wide variety of devices for rendering images. The term display device is also intended to include hardcopy devices, such as printers and plotters. The term display device additionally refers to all types of display devices, such as CRT, LED, OLED, and plasma devices, without regard to the particular display technology employed.

The image sensor 28 may be capable of providing frames in two or more different resolutions. For example, the image sensor may provide either full or low resolution frames. The full resolution frames are typically output at a rate lower than a video frame rate. The low resolution frames may be output at a video frame rate, such as 30 fps, for viewing on the display screen 26a, which may be a low resolution display screen. High resolution frames may be stored in the memory 38, the memory 29, or another memory such as a non-volatile memory, e.g., a Flash memory card for permanent retention or subsequent transmission to or viewing or printing on a high resolution display device. The low resolution frames may be discarded after viewing. To further illustrate, full or high resolution may be 480×640, for example, whereas low resolution may be 120×160.

A camera interface 40 (“CAM I/F”) in the display controller 22 receives pixel data output on data lines of a bus 42 coupled with the image sensor 28. Vertical and horizontal synchronizing signals as well as a camera clocking signal may be transmitted via the bus 42 or via a separate bus.

A memory 38 is included in the display controller 22. The memory 38 may be used for storing image data and other types of data. In other embodiments, however, the memory 38 may be remote from the display controller 22. The memory 38 is of the SRAM type, but the memory 38 may be a DRAM, Flash memory, hard disk, optical disk, floppy disk, or any other type of memory.

A memory controller 42 is coupled with at least the memory 38, the host interface 32, and the camera interface 40 thereby permitting the host 24 and the image sensor 28 to access the memory. Data may be stored in and fetched from the memory 38 under control of the memory controller 42. In addition, the memory controller 42 may cause image data it receives from the image sensor 28, memory 29, or host 24 to be presented to a pixel modifying unit 44. Generally, the memory controller 42 provides image data to the pixel modifying unit 44 in a particular order, e.g., raster order.

The pixel modifying unit 44 is provided in the display controller 22 for filtering at least one region of a frame of image data according to one of the claimed inventions. The pixel modifying unit 44 is coupled with the memory controller 42 so that it may receive image data from any image data source coupled with the memory controller, e.g., the host 24, the image sensor 28, or the memory 38. The pixel modifying unit 44 is coupled with a parameter memory 46 which stores information used by the pixel modifying unit 44. In one embodiment, the parameter memory 46 is a plurality of registers. Alternatively, the parameter memory 46 may be an area of memory within the memory 38.

The pixel modifying unit 44 is coupled with and presents pixels to a display pipe 48. Image data are then transmitted through the display pipe 48 to the display interface 36. In one embodiment, the display pipe 48 is a FIFO buffer. From the display interface 36, image data is passed via the display device bus 34 to the display device 26.

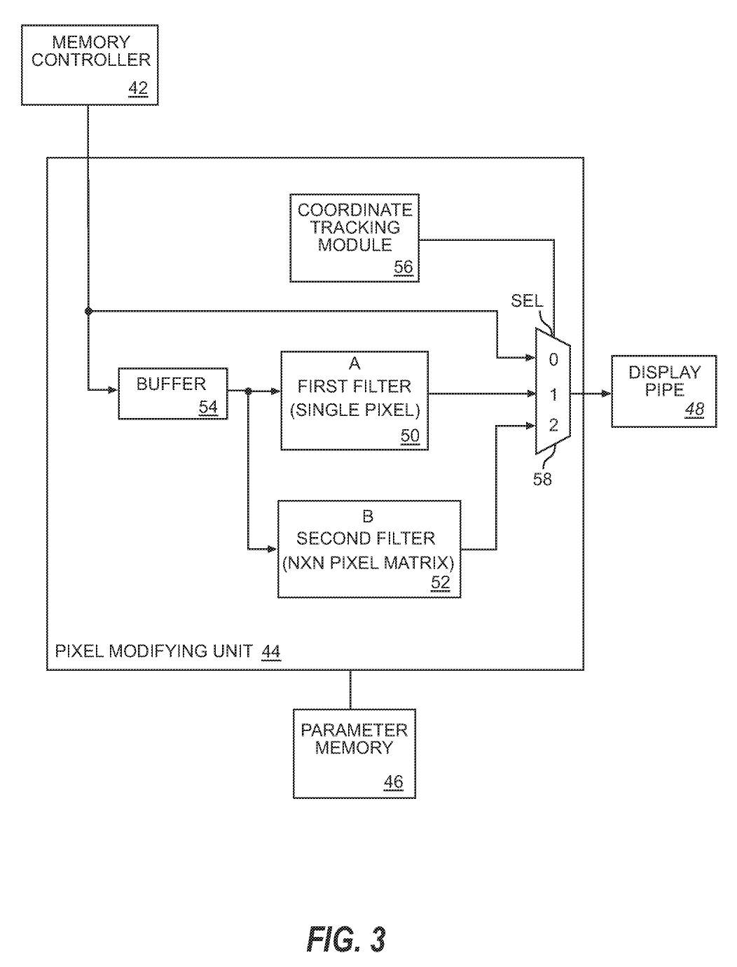

FIG. 3 is a block diagram illustrating one example of a pixel modifying unit. The pixel modifying unit 44 includes (a) a selecting circuit to select particular pixels of a frame of image data that have pixel coordinates that are within a region specified for filtering, and (b) at least one filtering circuit to modify the selected pixels according to a filtering operation specified for the region. The exemplary pixel modifying unit 44 includes two filters, i.e., first and second filters 50, 52. However, in alternative embodiments, any number of filters may be provided. In one embodiment, one filter is provided. The first filter 50 may be of the first type described above, and the second filter 52 may be of the second type. In addition, the pixel modifying unit 44 includes an optional buffer 54, a coordinate tracking module 56, and a selecting unit 58. Image data is presented to the “0” data input of the selecting unit 58 and to the buffer 54. The output of the buffer 54 is coupled with the inputs of the first and second filters 50, 52. The outputs of the first and second filters 50, 52 are coupled, respectively, with “1” and “2” data inputs of the selecting unit 58.

The shown selecting unit 58 has three data inputs, an output, and a selecting input “SEL.” The output of the coordinate tracking module 56 is coupled with the selecting input SEL of the selecting unit 58. The third data input of the selecting unit 58 is coupled with the memory controller 42. In one embodiment, the selecting unit 58 may be a three-to-one multiplexer. In an alternative embodiment, the selecting unit 58 may be a two-to-one multiplexer. More generally, the selecting unit 58 may be any type of decoding circuit for selecting among one of two or more inputs.

The coordinate tracking module 56 monitors the presentation of image data by the memory controller 42 and identifies the coordinate position of each presented pixel within the frame. The coordinate tracking module 56 determines for each pixel presented whether the pixel is within a region of the frame designated for filtering. If more than one region has been designated for filtering, the coordinate tracking module 56 determines whether a particular pixel is within one of the regions designated for filtering. The coordinate tracking module 56 may identify the position of the pixel within the frame by comparing the unique row and column coordinates associated with each pixel with the boundary coordinates of each region designated for filtering.

The parameter memory 54 may store coordinates for each region within the frame that has been specified for filtering, and the coordinate tracking module 56 accesses the parameter memory 54 as part of its function of determining whether a presented pixel is within at least one region of the frame designated for filtering. For example, the parameter memory 54 may store horizontal start and stop coordinates, and vertical start and stop coordinates that define the boundaries of each region specified for filtering. In addition, the parameter memory 54 may store information associated with each region to be filtered. This information may include specifying a particular filter, e.g., apply filter 50 to region 16 and filter 52 to region 18. Further, this information may include specifying particular parameters for a filter, e.g., filter region 16 using filter 50 and a first parameter, and a filter region 18 using filter 52 but with a second parameter.

If a particular pixel is not within a region to be filtered, the coordinate tracking module 56 causes the pixel to be passed to the display pipe 48 without filtering by, for example, selecting the “0” input to the selecting unit 58. On the other hand, if a particular pixel is within a region to be filtered, the coordinate tracking module 56 causes the pixel to be passed to the buffer 54. From the buffer 54, the pixel is then passed to the filters 50, 52 for filtering by one of the filters. The coordinate tracking module 56 also causes the output of one of the filters to be passed to the display pipe 48 by, for example, selecting the “1” or “2” input to the selecting unit 58.

The buffer 54 is required only where a filter that requires multiple pixels as input is included in the pixel modifying unit 44. In one alternative, the coordinate tracking module 56 causes a pixel to be passed to a filter without buffering, such as where the filter is of the type that requires a single pixel as input. In addition, the buffer 54 may be omitted even where the filter is of the type that requires multiple pixels as input, provided the memory controller fetches all of the two or more pixels needed for a filtering operation. However, because this may require repeated fetches from the memory 38, use of the buffer 54 is desirable for use with filters of the second type.

The buffer 54 has the capacity to store at least two pixels. The capacity required for the buffer 54 depends on the requirements of the filter. If the second filter 52 uses a 3×3 filter window, the buffer 54 may have the capacity to store three lines of pixels. If the second filter 52 uses a 9×9 filter window, the buffer 54 may have the capacity to store nine lines of pixels.

The coordinate tracking module 56 may cause two of more pixels to be stored in the buffer 54. Furthermore, the coordinate tracking module 56 may “look ahead” and anticipate that one or more pixels will be needed for a subsequent filtering operation. In other words, the coordinate tracking module 56 may determine whether a presented pixel will be needed for filtering a pixel that has not yet been presented and if the presented pixel will be needed, the module 56 causes it to be stored in the buffer 54. In one alternative, the tracking module 56 fills the line buffer 54 with one or more lines of pixels, beginning with the first line of the frame. In another alternative, the tracking module 56 does not start filling the line buffer 54 until it determines that a currently presented pixel will be needed in a subsequent filtering operation. For example, if row N is the first row of the region designated for filtering by a 3×3 filter, the tracking module 56 monitors the presentation of pixels and when line N−1 is presented, it begins causing pixels to be store in the line buffer 54.

The coordinate tracking module 56 also controls which pixels are transferred from the buffer 54 to a filter. If a filter of the first type is used, e.g. filter 50, a single pixel is transferred to the filter. If a filter of the second type is to be used, i.e., the filter requires a multiple pixels as input, e.g., filter 52, the coordinate tracking module 56 causes the pixels that the filter needs to be transferred from the buffer 54 to the filter. As a particular pixel stored in the buffer 54 may be needed for more than one filtering operation, the same pixel may be forwarded to the filter more than once. In an alternative where the buffer 54 is omitted, the coordinate tracking module 56 causes the pixels that the filter needs to be transferred from the image data source, e.g., the memory 38, to the filter.

The pixel modifying unit 44 may be capable of performing two of more distinct filtering operations. As mentioned above, the parameter memory 46 specifies one or more regions to be filtered. For each designated region, the parameter memory 46 specifies a particular filter and may specify particular coefficients or parameters. In one embodiment, the pixel modifying unit 44 may perform N filtering operations using N distinct filters. In an alternative embodiment, the pixel modifying unit 44 may perform N filtering operations using fewer than N filters by varying filter coefficients or parameters. In this alternative, for example, one filter can be used to perform two or more filtering operations by changing filter coefficients. Thus, two or more distinct filtering operations may be applied to two or more different regions of a frame using a single filter by using different filter coefficients for each region. Because two or more filtering operations are generally possible, distinct filtering operations may be simultaneously applied to different regions of a frame.

The filter effects may be created with a minimal amount of processing, allowing the effect to be created faster and using less power than required with known methods. In addition, filter effects may be created in real-time. This permits memory requirements to be reduced because there is no or little need to buffer image data. Further, this permits a user to view multiple filter effects virtually instantaneously and before the image is captured.

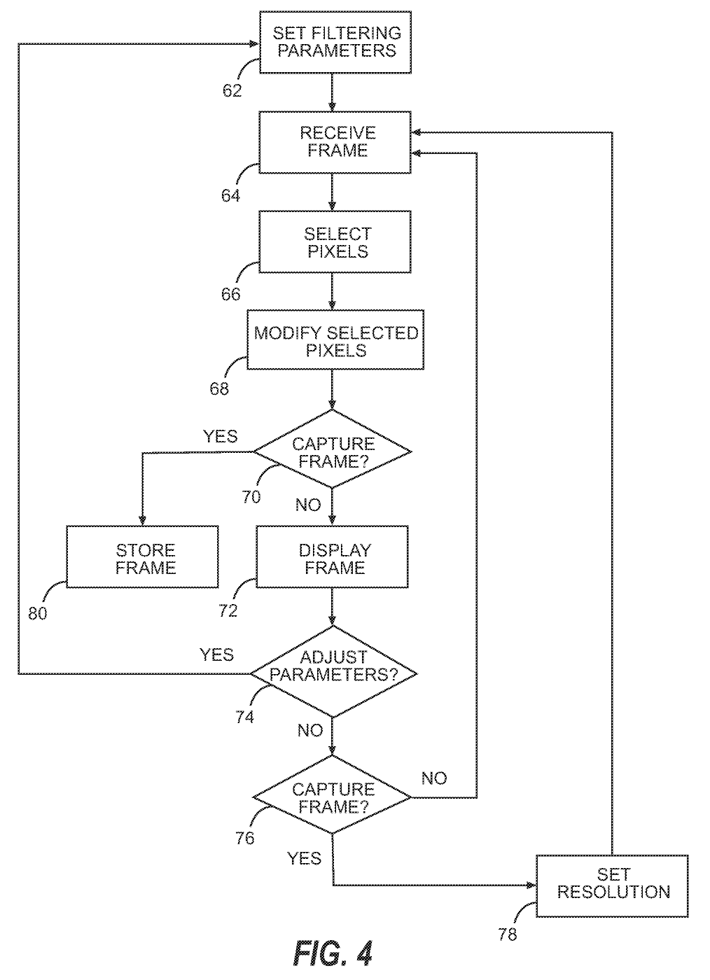

FIG. 4 is a flow diagram of a method according to one embodiment. The image data presented to the pixel modifying unit 44 may represent a high-resolution or low-resolution image. Image data may be provided in a high- or low-resolution format by the image data source. Alternatively, the display controller 22 may include an optional sampling unit 60 that transforms a frame of image data having an original resolution to a second resolution, wherein the second resolution is less than the original resolution. For example, the sampling circuit 60 may be employed to transform high- or full-resolution frames of image data to a reduced- or low-resolution frame. According to the method of FIG. 4, a stream of low-resolution frames are received and displayed as a video image on a display screen and are viewed by a user, for example, when “framing a shot”. The user sets one or more filtering parameters and one or more filtering operations are applied to the video image. The user may interactively adjust filtering parameters, which modifies the display video image, until he is satisfied with the filtering operation. Once satisfied, the user may capture the image as a photograph at high-resolution.

More specifically, in a step 62, one or more regions of the frame are designated for filtering and for each designated filtering region, a filtering operation is specified. A frame is received (step 64). Preferably, the received frame is a low-resolution frame, though this is not essential. (A low-resolution frame may be processed faster and using less power than a high-resolution frame and may be sufficient for viewing the filtering operation on the display screen.) The specified filtering operation is applied to the designated filtering region(s) (steps 66 and 68). The method performs a test in step 70 to determine whether the user has elected to capture the frame. The frame is displayed in step 72. Another test is performed in step 70 to determine whether the user wishes to modify the filtering parameters, e.g., change a filtering region or filtering operation. If the user is not satisfied with the video image, the methods returns to the step 62 of setting filter parameters. On the other hand, if the user is satisfied with the filtering operation, he is provided an opportunity to permanently capture the image in step 76. If the user does not wish to capture the image, the method returns to step 64. However, if the user does wish to capture the image, he may, for example, press a “shutter” button to take a photograph. One effect of determining to capture a frame is that the camera module may be caused to output a single frame at high resolution (step 78). Alternatively, the sampling circuit 60 may be deactivated (step 78). In yet another alternative, the step 78 may be skipped and the frame may be captured without changing the resolution. In addition, after it has been determined that a frame is to be captured, the method returns to step 64 where a subsequent frame is captured. The specified filtering operation is again applied to the designated filtering region(s) (steps 66 and 68), however, the operation is applied to the subsequent frame. When the method performs the test in step 70 to determine whether the user has elected to capture the frame, the method branches to step 80 where the frame may be stored in a memory. The frame may be stored in the memory 44 or another memory such as a non-volatile memory, e.g., a Flash memory card.

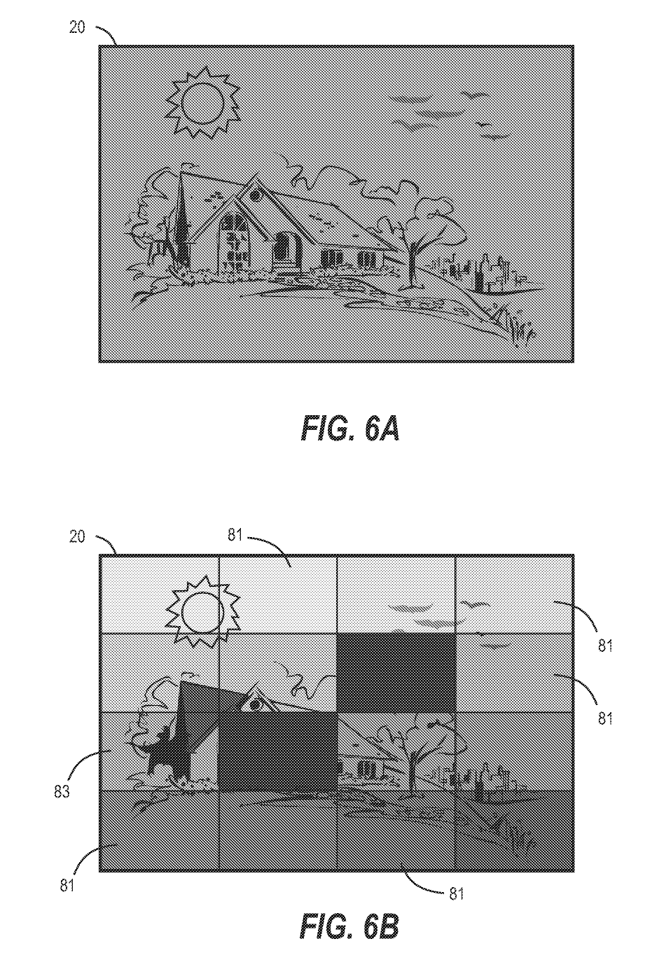

In one alternative embodiment, a stream of low-resolution video frames may be provided to the pixel modifying unit 44 for filtering two or more selected regions of a stream of video frames in real-time. As one example, FIG. 6A shows an original image of a scene viewed, for example, in a low-resolution mode, without filtering. FIG. 6B shows an exemplary image of the same scene after distinct filtering operations have been performed on 15 like-size filtering regions 81. (One region 83 is not filtered).

Assume that the original image shown in FIG. 6A is too dark due to low light conditions and it is desired to lighten the image. FIG. 6B shows 15 filtering regions 81 that are either lighter or darker than the original frame 20. For comparison purposes, the filtering region 83 is unfiltered. In this example, the same filter is applied to each of the regions 81, but different filter coefficients are used for each of the regions. Preferably, the filtering operations are predetermined, thought this is not essential. As FIG. 6B illustrates, the casual photographer, who wants to take a photograph and wishes to filter the image to improve image quality, can immediately can see and preview the results of applying various filter parameters or various filters in real-time. The preview filtering operations may be performed on either a low- or high-resolution image. After previewing the various filtering operations, the user may select one of the filtering operations and have that operation applied to the entire image. The image may then be captured at high-resolution as a photograph.

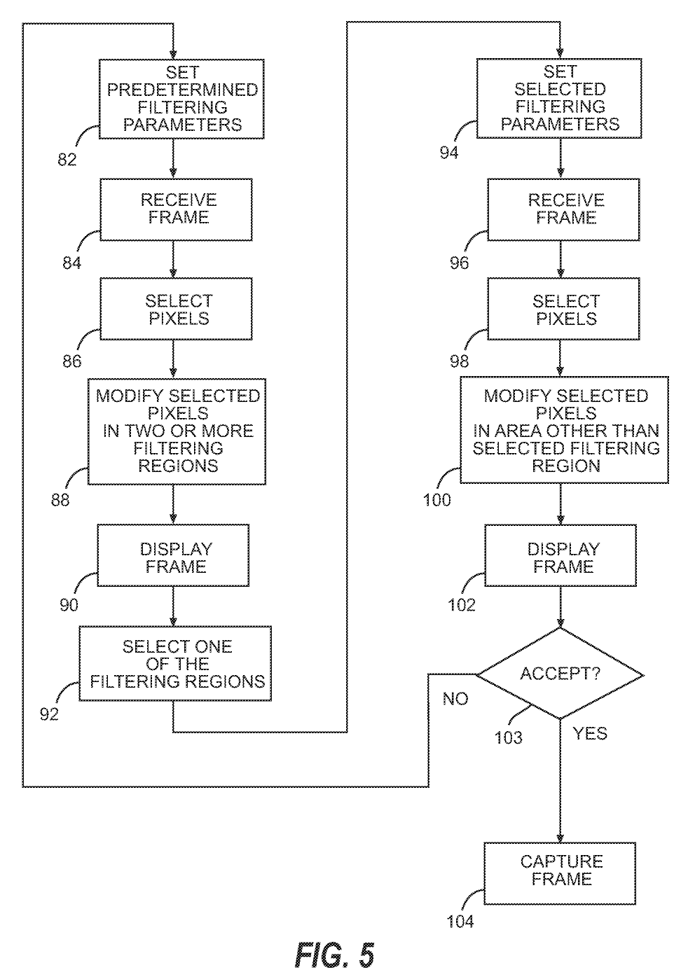

FIG. 5 is a flow diagram of the method described generally above with respect to FIGS. 6A and 6B. First, filtering regions and filtering parameters for each of the regions are set (step 82). In one alternative, the filtering regions and filtering parameters predetermined. Preferably, two or more filtering regions are specified. A frame of image data is received (step 84). Pixels within the filtering regions are selected (step 86), and the selected pixels are modified according to the filtering operation for the filtering region in which the selected pixel is located (step 88). Preferably, two or more filtering operations are specified. The filtered frame is displayed (step 90). The user may then select one of the filtering operations by selecting one of the filtering regions (step 92). Based on the selection, the filtering parameters associated with the selected filtering operation are set for at least one other area of the frame (step 94). For example, the selected filtering operation may be applied to the entire frame. A subsequent frame is received in step 96. Pixels of the subsequent frame within a filtering region are selected (step 98) and modified according to the selected filtering operation (step 100). The frame is displayed (step 102). At step 103, the user may accept or reject the frame. In step 104, an accepted frame may be captured. As described above, the “capturing” of a frame may involve setting the resolution at which a subsequent frame will be received. Further, the capturing of a frame may involve receiving, modifying, and storing a subsequent frame.

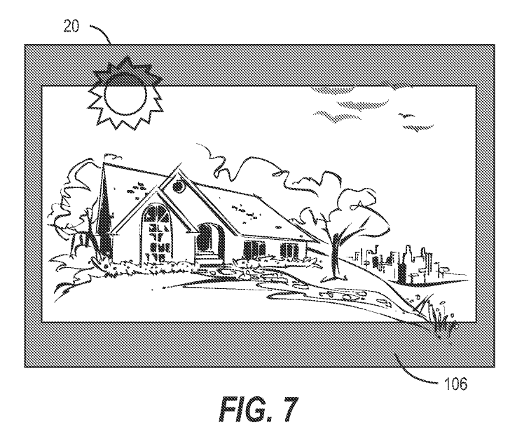

Turning now to FIG. 7, an example of how a frame around a photograph may be created is shown. In FIG. 7, a designated filtering region 106 is picture-frame shaped. A filtering operation that causes the filtering region 106 to appear black, white, a particular color, or blurred may be selected.

Extending the example of FIG. 7, a filtering region that defines the background region of a photograph may be specified. For example, a person's face may appear in a foreground portion of the image with other objects appearing in the background, i.e., in the filtering region. Assume that either the foreground or background needs to be made brighter or darker. A suitable balance between the light and dark areas may be achieved by performing a filtering operation on the background filtering region. Alternatively, it may be desired to increase emphasis on the foreground portion by applying a blur filtering operation to the background portion.

The pixel modifying unit may be comprised of a plurality of discrete logic gates and devices selected and designed to perform the functions described as well as other functions. Alternatively, the pixel modifying unit may be comprised of logic gates and devices produced by a hardware definition language, such as Verilog™ or VHDL. In another alternative, the pixel modifying unit may be comprised of a suitable processor and a memory to execute a program of instructions stored in the memory together with image data for one segment of original image pixels, wherein the program of instructions when executed by the processor performs a method to create modified pixels from original image pixels according to the method described above. In addition, the parameter memory 46 may comprise one or more than one storage devices. The parameter memory 46 may be a discrete device such as a flip-flop or a plurality of flip-flops integrated on the IC of the display controller, or it may comprise one or more storage locations in a memory, such as the memory 44.

The claimed inventions may be embodied as a machine readable medium embodying a program of instructions for execution by the machine to perform a hardware implemented method for filtering regions of a frame of image data. The machine or computer readable medium may be any data storage device that can store data which can be thereafter read by a computer system. The computer readable medium may also include an electromagnetic carrier wave in which the computer code is embodied. Examples of the computer readable medium include flash memory, hard drives, network attached storage, ROM, RAM, CDs, magnetic tapes, and other optical and non-optical data storage devices. The computer readable medium can also be distributed over a network-coupled computer system so that the computer readable code is stored and executed in a distributed fashion.

The term “real-time,” as used in this specification and in the claims, refers to operations that are performed with respect to an external time frame. More specifically, real-time refers to an operation or operations that are performed at the same rate or faster than a process external to the machine or apparatus performing the operation. As an example, a real-time operation for filtering a region of a frame proceeds at the same rate or at a faster rate than the rate at which pixels are received from an image sensor or a memory, or as pixels are required by a display device or circuitry driving the display device.

In this document, references may have been made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places above are not necessarily all referring to the same embodiment. Furthermore, particular features, structures, or characteristics may be combined in one or more embodiments.

In this document, particular structures, processes, and operations well known to the person of ordinary skill in the art may not have been described in detail in order to not obscure the description. As such, embodiments of the claimed inventions may be practiced even though such details are not described. On the other hand, certain structures, processes, and operations may have been described in some detail even though such details may be well known to the person of ordinary skill in the art. This may have been done, for example, for the benefit of the reader who may not be a person of ordinary skill in the art. Accordingly, embodiments of the claimed inventions may be practiced without some or all of the specific details that are described. Moreover, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims.

Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

I claim:

1. A display controller comprising:
(a) a selecting circuit to select pixels of a frame of image data that are within at least one region of the frame designated for filtering; and
(b) at least one filtering circuit to modify the selected pixels according to a filtering operation specified for the filtering region in which the selected pixels are located.

2. The display controller of claim 1, wherein the selecting circuit selects pixels that are within one of at least two filtering regions, and the filtering circuit modifies the selected pixels according to one of at least two distinct filtering operations.

3. The display controller of claim 2, further comprising a buffer to store image data for filtering operation.

4. The display controller of claim 2, further comprising a sampling circuit to sample a first frame of image data and to produce a sampled first frame having a first resolution.

5. The display controller of claim 2, further comprising a parameter memory.

6. The display controller of claim 2, wherein the display controller is incorporated into a mobile device.

7. The display controller of claim 2, wherein the at least one filtering circuit includes first and second filtering circuits and the first filtering operation is performed by the first filtering circuit and the second filtering operation is performed by the second filtering circuit.

8. The display controller of claim 2, wherein the at least one filtering circuit includes a first filtering circuit and the first and second filtering operations are performed by the first filtering circuit using distinct filtering parameters.

9. The display controller of claim 2, wherein the first and second filtering operations are performed in real time.

10. The display controller of claim 9, further comprising a first interface circuit to receive frames of image data at a first frame rate and a second interface circuit to transmit frames of image data to a display device at a second frame rate, wherein the selecting circuit selects pixels and the filtering circuit modifies pixels at a rate at least as fast as the faster of the first and second frame rates.

11. A hardware implemented method for filtering image data, comprising:
(a) receiving at least one frame of image data;
(b) selecting pixels of the frame that are within a region of the frame designated for filtering; and
(c) modifying the selected pixels according to a filtering operation specified for the region.

12. The method of claim 11, wherein the at least one frame of image data includes two or more sequential frames, a first frame in the sequence being at a first resolution, a second frame in the sequence being at a second resolution, wherein the first resolution is lower than the second resolution.

13. The method of claim 12, wherein the at least one frame of image data is received from an image sensor.

14. The method of claim 12, further comprising displaying the first frame on a display device.

15. The method of claim 14, further comprising setting a filter parameter after the step of displaying the first frame.

16. The method of claim 15, further comprising storing the second frame in a memory, wherein the step of setting a filter parameter is performed before storing the second frame.

17. The method of claim 11, wherein the at least one frame of image data includes two or more sequential frames, the sequence of frames including first and second frames, further comprising a step of sampling the first frame, the sampled first frame being at a first resolution, the second frame being at a second resolution, wherein the first resolution is lower than the second resolution.

18. A hardware implemented method for filtering image data, comprising:
(a) receiving at least one first frame of image data;
(b) selecting pixels of the first frame that are within a region designated for filtering, wherein at least two filtering regions are designated, and wherein at least two filtering operations are specified;
(c) modifying the selected pixels according to the filtering operation specified for the filtering region in which the selected pixels are located; and
(d) displaying the first frame, after the step of modifying the selected pixels, on a display device.

19. The method of claim 18, further comprising:
(e) selecting one of the at least two designated filtering regions subsequent to displaying the first frame.
(f) receiving at least one second frame of image data subsequent to receiving the first frame;
(g) selecting at least one pixel of the second frame that is in an area of the second frame other than the selected filtering region; and
(h) modifying the selected pixels according to the filtering operation specified for the selected filtering region.

20. The method of claim 19, wherein the at least two designated filtering regions are predetermined.

21. The method of claim 20, wherein the at least two specified filtering operations are predetermined.

22. The method of claim 19, wherein the at least one first frame is of a first resolution, the at least one second frame is of a second resolution, and the first resolution is less than the second resolution.
